(19) United States
(12) Patent Application Publication
(10) Pub. No.: US 2006/0154708 A1
(43) Pub. Date: Jul. 13, 2006

(54) Personal portable external cell phone antenna

(75) Inventor: Bruce Fredric Bogner, Margate, NJ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Brehn Corporation

(21) Appl. No.: 11/233,908

(22) Filed: Sep. 23, 2005

Related U.S. Application Data
(60) Provisional application No. 60/643,377, filed on Jan. 13, 2005.
(60) Provisional application No. 60/650,581, filed on Feb. 7, 2005.
(60) Provisional application No. 60/654,880, filed on Feb. 22, 2005.

(51) Int. Cl. H04M 1/00

(52) U.S. Cl. 455/575.7

(57) ABSTRACT

The present invention is a portable, self contained, dual frequency external antenna configuration for use with a phone, such as a cell phone having an outwardly extending antenna to enhance cell phone operation. The antenna configuration comprises a first antenna tuned to a first cell phone operating frequency and a second antenna tuned to a second cell phone operating frequency. A connector is provided, the connector adapted for making a connection to the cell phone and at least one transmission line connects the first and second antennas to the connector.

### CROSS-REFERENCE TO RELATED APPLICATIONS

This application claims the benefit of U.S. Provisional Patent Applications Nos. 60/643,377 filed Jan. 13, 2005; 60/650,581 filed Feb. 7, 2005; and 60/654,880 filed Feb. 22, 2005, the subject matter of each of which is hereby incorporated herein by reference.

### BACKGROUND OF THE INVENTION

This invention relates to a small device which incorporates patterns of electrically conductive lines in the configuration of antennas tuned to the operating frequencies of a cell phone which, when connected to said cell phone, enhances the performance of said cell phone.

The need for reliable wireless communication essentially gave rise to two different ways of achieving this result. One such system utilized a set of low earth orbiting satellites and hand held transceivers. This system provided very high reliable communication, but was too expensive to operate, the hand held devices were too large and expensive, and the two systems, Iridium and Globalstar filed for bankruptcy. The other system, utilizing small hand held devices that transmitted to a local antenna tower, outperformed the satellite systems in terms of size, cost and versatility. Now, only small hand held cell phones are in common use and antenna towers dot the landscape in order to provide the needed signal-to-noise ratio [S/N] for clear static free communication. The competition between the various suppliers of cell phones has resulted in cell phones becoming smaller and smaller. As size was reduced, the antenna attached to the cell phone also became smaller. To compensate for this, the power generated within the cell phone has been increasing. This trend had resulted in temperatures inside some cell phones to become high enough to overheat the cell phone batteries, which have been reported exploding. There is a need to increase the Effective Radiated Power [ERP] of a small cell phone so that the RF power generated within the cell phones can be minimized and personal safety increased. The solution is to increase the effectiveness of the antenna system for the cell phone.

Presently there are many external antennas for sale for just this purpose. A visit to the web site AlternativeWireless.com shows many antennas for sale that will improve the reception of a cellular phone. Wilson Electronics is a manufacturer of many models of such antennas. Some of these antennas are described in U.S. Pat. Nos. 6,788,261, 6,486,840, and 6,317,089 assigned to Wilson Electronics, Inc. and U.S. Pat. No. 6,714,164 assigned to Nippon Antenna Kabushiki Kaisha. These antennas are not intended to be carried around. There are numerous models for mounting on a vehicle or being placed upon a metallic surface in a home or office to improve operation. One such antenna is the “Wilson Mini Dual Band Magnetic Mount Antenna”. All these antennas have one characteristic in common. They are only ½ of the antenna. They rely on being mounted on a fairly large metallic surface in order to create an image below the metallic surface, thereby creating the virtual entire antenna structure, a ½ wave dipole tuned to the cell phone frequencies of operation. However, there are no portable antennas being offered for sale to significantly improve the performance of the cell phone of the average user that operate without the need for such a metallic surface.

A visit to the Factory Direct Cellular web site reveals three small antennas that claim to provide some improvement in cell phone reception. One such device is called a “cellular Antenna Booster” that fits inside a cell phone case and claims to provide some improvement. The other devices shown are designed to attempt to transfer signals from inside a vehicle to the outside, thereby providing some measure of improvement. However, until now, there are no practical portable antennas that provide significant improvement in cell phone reception. Such an antenna must be easy to carry around and easy to connect to the cell phone when improved performance is desired/required.

The present invention solves this problem by incorporating full ½ wave dipole antennas into a small assembly that can be attached to a cell phone so that the user has the advantage of an external antenna to enhance the operation of the cell phone without the cumbersome problem of carrying around a bulky external antenna that must be mounted on a metallic surface in order to be utilized. Without an external antenna, a cell phone increases the RF energy generated within the cell phone in order to achieve a secure link to a nearby tower. If a secure link to the tower cannot be achieved, the call is lost. Use of an external antenna increases the probability of achieving a secure link to a tower, thereby allowing the call to be completed, as well as minimizing the RF energy generated within the cell phone, thereby minimizing any health risks associated with holding a cell phone directly to one's head. This invention is the first use of such technology to enhance cell phone performance. Several field trials utilizing an embodiment of the present invention have been conducted. Reliable reception was achieved in places where no service was obtainable, notably in the mountains in New Hampshire, on the beach in Southern New Jersey, in the mountains north of San Francisco, and in the vehicle of a traveling salesman, who claims to have, for the first time, never lost a call while traveling.

There are several reasons why one skilled in the antenna art has not come up with an antenna configuration similar to the present invention. The antenna on the cell phone is obviously inadequate to provide a high gain link to a remote tower. So it was obvious that it made sense to bypass this antenna by connecting directly to the circuitry inside the phone, either via a coaxial connection provided by the manufacturer or by removing the cell phone antenna and plugging in a well-designed external antenna. Regarding the design of an external antenna, it was “obvious” that an omni-directional radiation pattern would be ideal since one does not know the direction to the nearest tower. Then there is the problem that the antenna must cover two separate frequency bands, separated by more than a 2:1 ratio. There are numerous classical methods of combining two frequency bands such as these into a single omni-directional configuration. It is complicated, but has been done for a long time. Once one has a dual frequency omni directional antenna in mind, utilizing a metallic ground plane to eliminate the need to fabricate the entire dipole structure appeared apparent, especially when it was the customer who had to supply the ground plane. Finally, there was the unknown effect of the human body on the operation of an antenna in close proximity. For these various reasons, external antennas for sale to the public are omni-directional and plug into the phone. The fact that each model phone requires a different type connection, and that the customer must provide a metallic ground plane beneath the antenna are factors that the designers of external cell phone antennas felt they just had to live with.

A personal portable external cell phone antenna includes a small dual frequency antenna and a means to make a connection to a cell phone. The antenna incorporates a number of narrow lines capable of conducting an electrical signal. The configuration of said conductive lines forms an antenna or array of antennas which is tuned to the frequency or frequencies of cell phone operation. According to a particularly advantageous aspect of the invention, a means is provided to couple the antenna to the antenna of a cell phone. In another particularly advantageous aspect of the invention, a means is provided to reduce the size of the antenna assembly to make it convenient to carry it on one's person. Use of the invention enhances the performance of a cell phone and increases personal safety by minimizing the RF power generated within said cell phone.

Antennas tuned to the frequency of operation of a cell phone [806-894 MHz, referred to as the 850 MHz band, and 1850-1990 MHz, referred to as the 1950 MHz band, or some other frequency of operation] are incorporated in a small assembly. The assembly incorporates a means for the antennas to be connected to a cell phone. The user connects the assembly to a cell phone in order to improve the performance of the cell phone. In the preferred embodiment of the invention, the antenna couples directly to the antenna of the cell phone antenna, thereby making it a more universal type connection, not depending upon the different means of making a direct connection to the various models of cell phones currently on the market. In another embodiment of the invention, the connection to the cell phone is via a commercially available external antenna adapter which is recommended by the manufacturer of a particular cell phone. Each cell phone on the market essentially has a different means for connecting to an external antenna, requiring a special adapter for each cell phone model. This invention, in its present form, will enhance signals in what is called the “quad-band” which includes the frequencies of 850, 900, 1800 and 1900 MHz.

### BRIEF SUMMARY OF THE INVENTION

Briefly stated, in one embodiment, the present invention comprises a portable, self contained, dual frequency external antenna configuration for use with a phone, such as a cell phone having an outwardly extending antenna to enhance cell phone operation. The antenna configuration comprises a first antenna tuned to a first cell phone operating frequency and a second antenna tuned to a second cell phone operating frequency. A connector is provided, the connector adapted for making a connection to the cell phone and at least one transmission line connects the first and second antennas to the connector.

In another embodiment, the present invention comprises a portable, self contained, external antenna configuration for use with a phone, such as a cell phone having an outwardly extending antenna to enhance cell phone operation. The antenna configuration comprises at least a first antenna tuned to a cell phone operating frequency, a connector adapted for making a connection to the cell phone and at least one transmission line connecting the first antenna to the connector.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a simplified pictorial of a cell phone showing a typical cell phone antenna;

FIG. 2 is a detailed pictorial of an 850 MHz antenna combined with a 1950 MHz antenna according to a preferred embodiment of the present invention;

FIG. 3 shows the antenna of FIG. 2 connected to a multiple loop antenna via a two wire transmission line;

FIG. 4 shows the antenna configuration of FIG. 3 connected to a cell phone antenna in a wireless manner, according to a preferred embodiment of the present invention;

FIG. 5 shows the antenna of FIG. 2 connected to a multiple loop antenna via a coaxial cable;

FIG. 6 shows the antenna configuration of FIG. 5 connected to a cell phone antenna in a wireless manner, according to a preferred embodiment of the present invention;

FIG. 7 shows the antenna configuration of FIG. 3 connected to a cell phone antenna, according to a preferred embodiment of the present invention where the antenna is configured as a printed circuit;

FIG. 8 shows the antenna configuration of FIG. 5 connected to a cell phone antenna, according to a preferred embodiment of the present invention, where the antenna is configured as a printed circuit;

FIG. 9 is a simplified pictorial showing a person holding a cell phone to his head with the antenna configuration of FIG. 3 attached to the cell phone antenna in a wireless manner, according to a preferred embodiment of the present invention;

FIG. 10 is a simplified pictorial showing a person holding a cell phone to his head with the antenna configuration of FIG. 5 attached to the person's wearing apparel and attached to the cell phone antenna in a wireless manner, according to a preferred embodiment of the present invention;

FIG. 11 is a simplified pictorial showing a person wearing a head set and wearing a cell phone at his waist with the antenna configuration of FIG. 5 attached to the person's wearing apparel and attached to the cell phone antenna in a wireless manner, according to a preferred embodiment of the present invention;

FIG. 12 is a simplified pictorial showing a person holding a cell phone in front of himself with the antenna configuration of FIG. 3 attached to the cell phone antenna in a wireless manner, according to a preferred embodiment of the present invention;

FIGS. 13A and 13B show the antenna configuration of FIG. 3 compressed and inserted into a container according to a preferred embodiment of the invention;

FIG. 14 shows an alternate embodiment of the antenna configuration of FIG. 3 wherein the antenna and the coil are constructed as flat strips;

FIG. 15 shows a preferred embodiment of the antenna assembly of FIG. 14 wherein the antenna and coils are a printed circuit on a non-metallic material;

FIG. 16 shows the antenna configuration of FIG. 15 connected to the antenna of a cell phone in one particular relative orientation;

FIG. 17 shows the antenna configuration of FIG. 15 connected to the antenna of a cell phone in a second relative orientation;

FIGS. 18A, 18B and 18C show the antenna configuration of FIGS. 13A and 13B connected to a cell phone and also the antenna configuration of FIG. 3 deployed in a preferred embodiment of the invention;

FIGS. 19A and 19B are diagrams depicting experiments conducted over the frequency band 1850 MHz to 1990 MHz to optimize the design of the antenna of FIG. 2 over that frequency band and to establish the performance of the antenna over that frequency band;

FIGS. 20A and 20B are diagrams depicting experiments conducted over the frequency band 806 MHz to 894 MHz to optimize the design of the antenna of FIG. 2 over that frequency band and to establish the performance of the antenna over that frequency band;

FIG. 21 shows the antenna configuration of FIG. 2 mounted in an antenna measurement facility;

FIG. 22 shows a perspective view of the setup of FIG. 21;

FIGS. 23A and 23B show the measured gain of the antenna of FIG. 2 resulting from measurements made in the setup of FIG. 21;

FIG. 24 shows the measured azimuth radiation pattern of the antenna of FIG. 2 at 1920 MHz resulting from measurements made in the setup of FIG. 21; and

FIG. 25 shows the measured azimuth radiation pattern of the antenna of FIG. 2 at 859 MHz resulting from measurements made in the setup of FIG. 21.

### DETAILED DESCRIPTION OF THE INVENTION

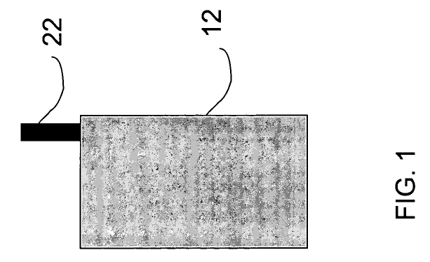

Referring to the drawings in detail, wherein like numerals indicate like elements throughout, FIG. 1 shows some detail of a typical cell phone 12 with a typical cell phone antenna 22.

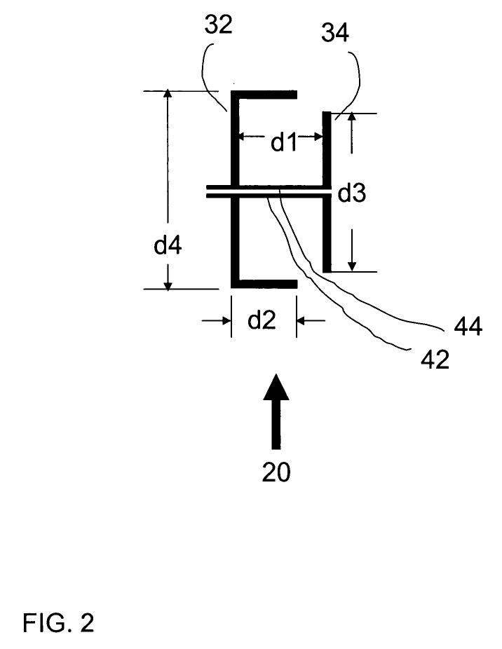

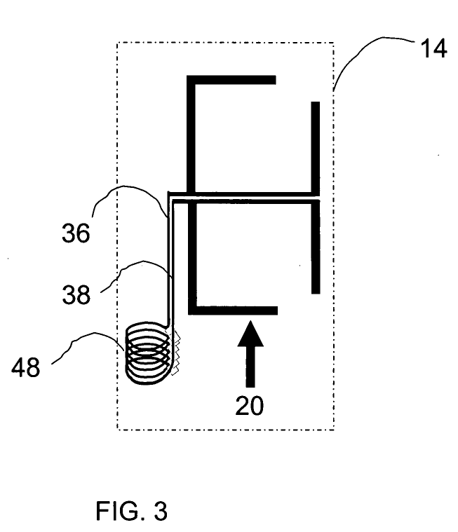

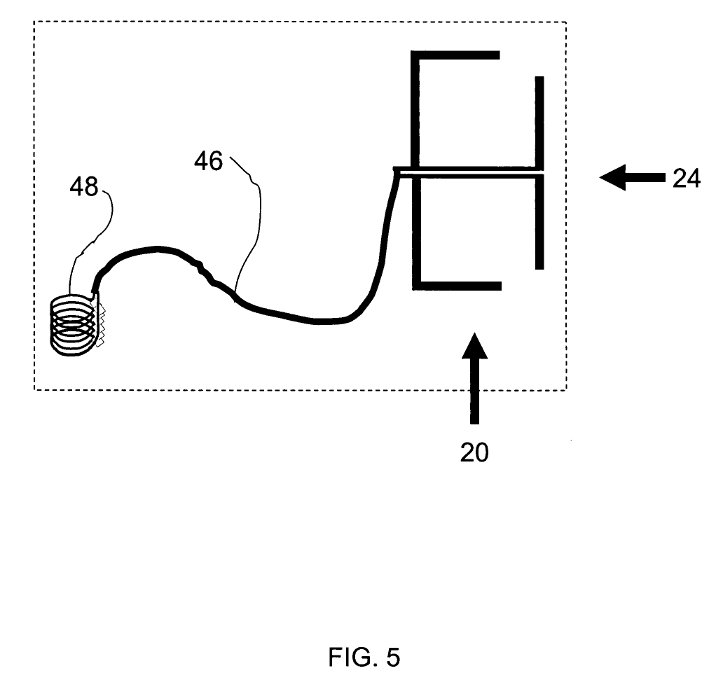

FIG. 2 shows in detail two different antennas 32 and 34, arranged in an assembly 20 to provide greater cell phone performance enhancement than a single frequency antenna. Antenna 32 is tuned to the 850 MHz band and antenna 34 is tuned to the 1950 MHz band. Dimension d2+d4+d2 is a half wavelength [λ/2] in the 850 MHz band and dimension d3 is a half wavelength [λ/2] in the 1950 MHz band. As antenna 32 and antenna 34 operate at different frequencies, there is no phase relationship between them, except that d1 should be as small as possible to realize the smallest possible overall size of the configuration that incorporates the present invention. By setting d1 at approximately λ/4 at 1950 MHz, antenna 34 can utilize antenna 32 as a reflector, thereby increasing the gain of antenna 34 in the plane of the assembly. The antennae are preferably made of metallic wire but some other material such as a printed circuit may be used. The two wire transmission lines 42 and 44 connect antennas 32 and 34 to transmission lines 36, 38 (FIG. 3) or 46 (FIG. 5).

FIG. 3 shows the antenna assembly 20, connected to a multiple loop wireless connector 48 via transmission lines 36, 38. The entire assembly will be referred to as antenna configuration 14 in subsequent figures. The multiple loops of the wireless connector 48 are preferably made of insulated wire but some other material such as a printed circuit may be used. The transmission lines 36, 38 are made of wire but some other material such as a printed circuit may be used. The antenna assembly 20 may be connected to the cell phone 12 in some other manner. For example, a coaxial connector (not shown) may be connected to the transmission lines 36, 38 for connection to a coaxial connector on the cell phone 12. Alternatively, the cell phone antenna 22 could be removable and a special connector (not shown) could connect the antenna assembly 20 to the cell phone 12 where the cell phone antenna 22 had been connected. Other connectors and methods of connecting the antenna assembly 22 to the cell phone will be apparent to those skilled in the art.

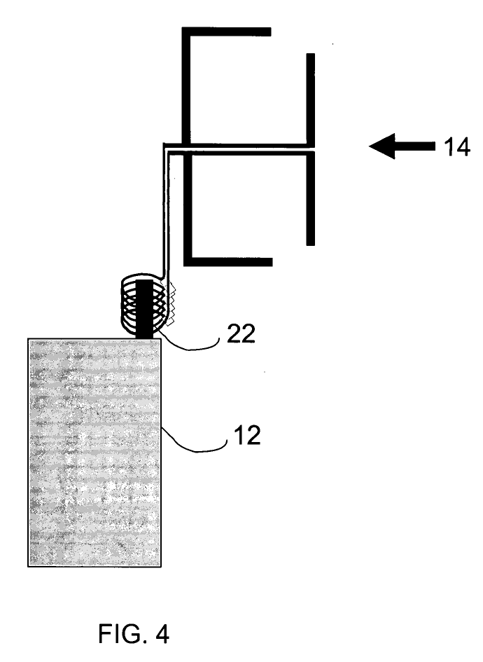

FIG. 4 shows the antenna configuration 14 mounted to cell phone 12 via the antenna 22. The antenna configuration 14 makes a wireless connection to the cell phone antenna 22.

FIG. 5 shows antenna assembly 20, connected to a multiple loop wireless connector 48 via transmission line 46. The entire assembly will be referred to as antenna configuration 24 in subsequent figures.

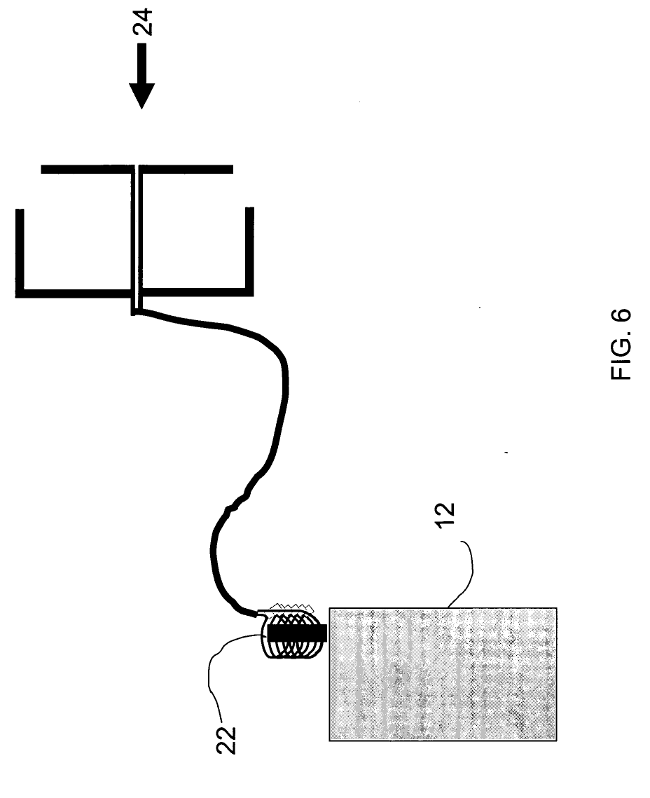

FIG. 6 shows antenna configuration 24, according to the present invention, mounted to cell phone 12 via antenna 22. Configuration 24, according to the present invention, makes a wireless connection to cell phone antenna 22 using the wireless connector 48.

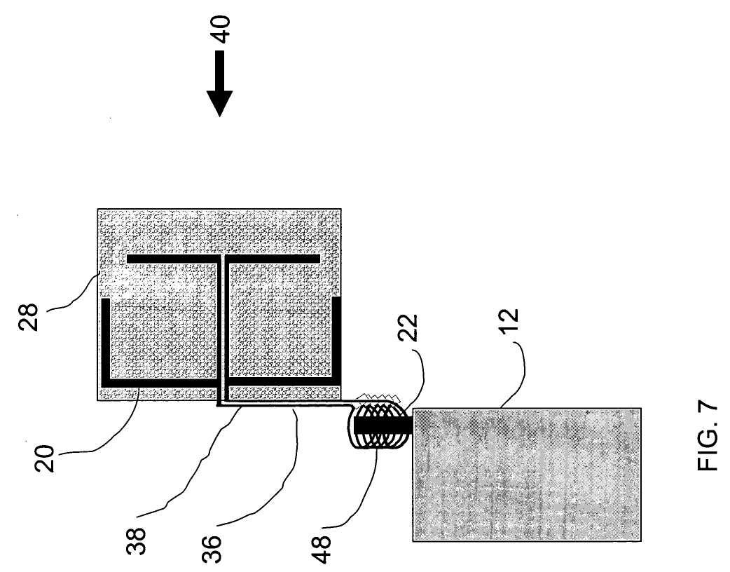

FIG. 7 shows a configuration 40 according to the present invention, mounted to the antenna 22 of cell phone 12 via the loops of the wireless connector 48 and transmission line 36, 38. Configuration 40 is shown as a printed circuit 28 which incorporates the configuration 20 of FIG. 5.

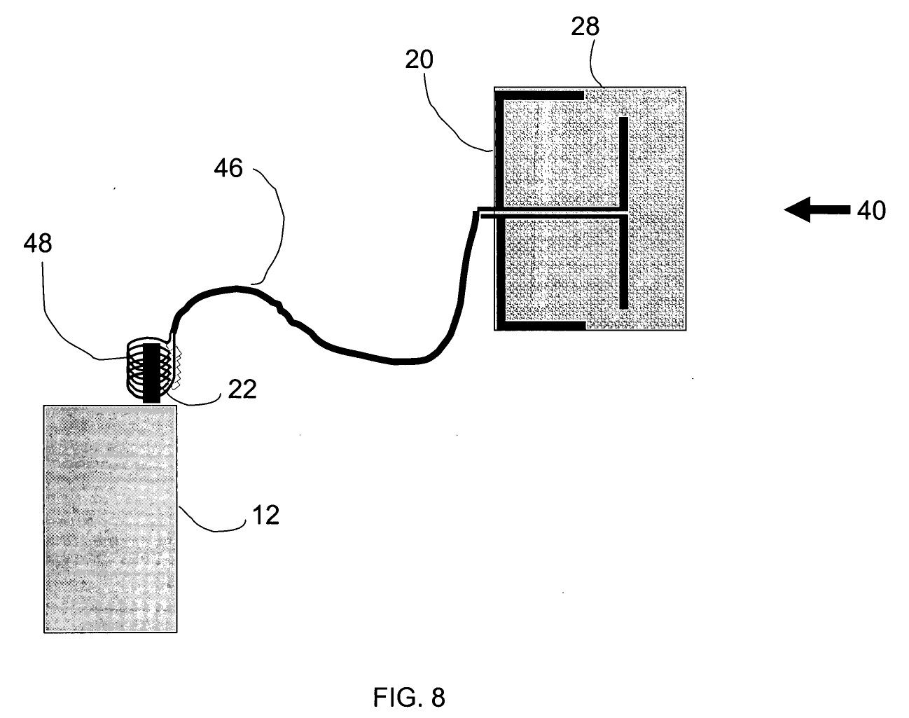

FIG. 8 shows configuration 40, according to the present invention, mounted to cell phone antenna 22 of cell phone 12 via the loops of wireless connector 48 and transmission line 46.

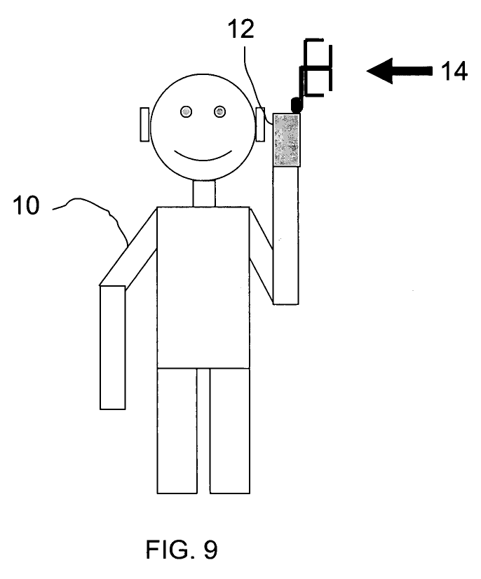

FIG. 9 shows a cell phone user 10 using a cell phone 12 with antenna configuration 14 as shown in FIG. 4 to his head in a deployed configuration. As shown, the antenna configuration 14 is supported by the cell phone 12.

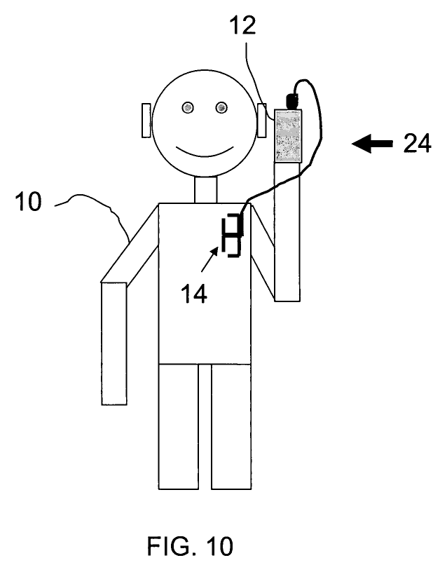

FIG. 10 shows a cell phone user 10 using a cell phone 12 with antenna configuration 24 as shown in FIG. 5 to his head in a deployed configuration. As shown, cell phone antenna configuration 14 is attached to the user's person in some manner.

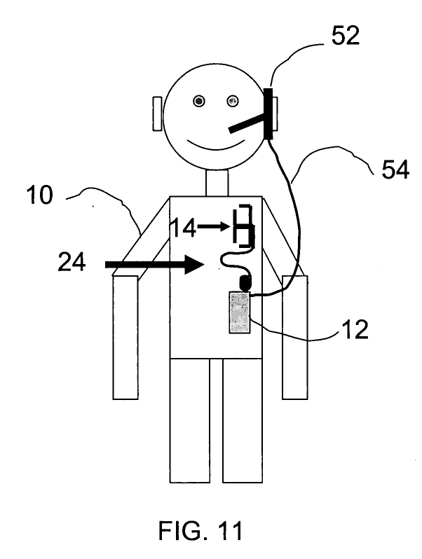

FIG. 11 shows a cell phone user 10 using a cell phone 12, with antenna configuration 24 as shown in FIG. 5. Cell phone 12 is mounted in an area in the vicinity of the cell phone user's waist in a deployed configuration. As shown, the antenna configuration 14 is attached to the user's person in some manner. Also shown is a headset 52 connected to cell phone 12 via a wire 54.

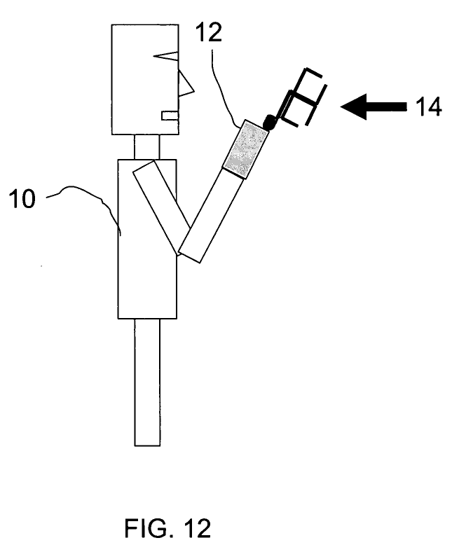

FIG. 12 shows a cell phone user 10 using a cell phone 12 with antenna configuration 14 as shown in FIG. 3 in a deployed configuration. The user is holding the cell phone 12 out in front of himself and can be employing a head set (not shown) or the speaker capability of the cell phone 12.

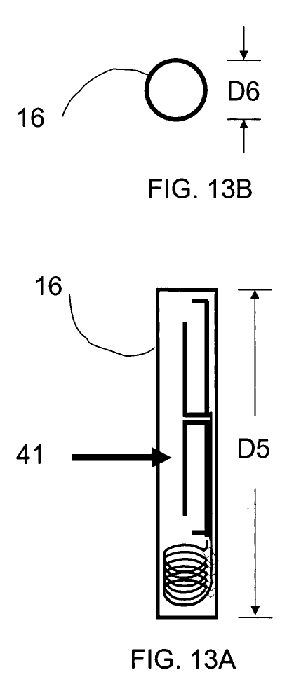

FIGS. 13A and 13B show one possible manner in which the external cell phone antenna can be stored as configuration 41 in a housing or container 16 when not mounted to a cell phone 12. The dimensions of the container 16 are shown as D5 long and D6 in diameter. Other container dimensions and configurations are possible within the spirit of the invention. Antenna configuration 41 is either folded, rolled or compressed in some manner in order for it to fit within container 16. Container 16 is small and designed such that the user can carry it on their person, and makes the cell phone antenna assembly, according to the present invention, available for use in any locality at any time.

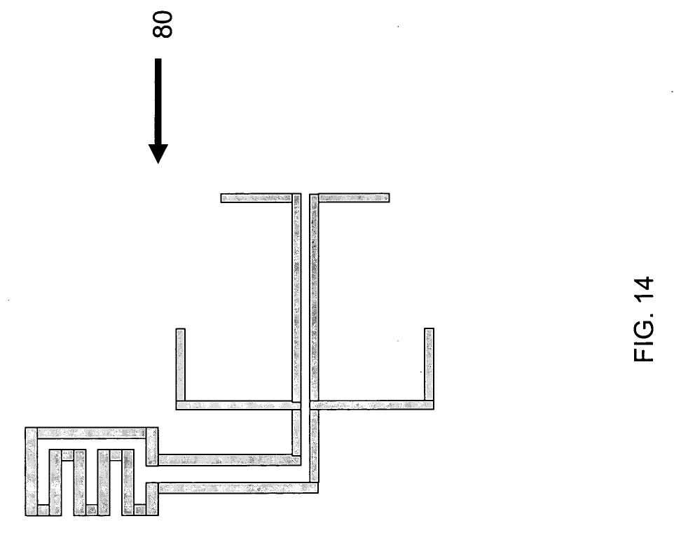

FIG. 14 shows an antenna configuration 80 as a flat strip version of the antenna configuration 14 shown in FIG. 3.

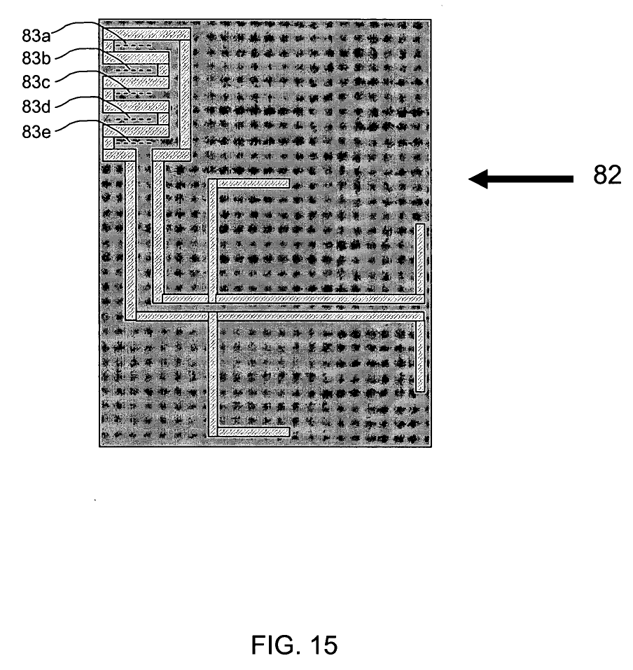

FIG. 15 shows an antenna configuration 82 fabricated as a printed circuit version of the antenna configuration 80 shown in FIG. 14. The slits 83a through 83e in the vicinity of the printed coil allow the printed coil to fit around the cell phone antenna 12 (not shown). There may be a different number of slits and coils than shown without violating the spirit of the invention.

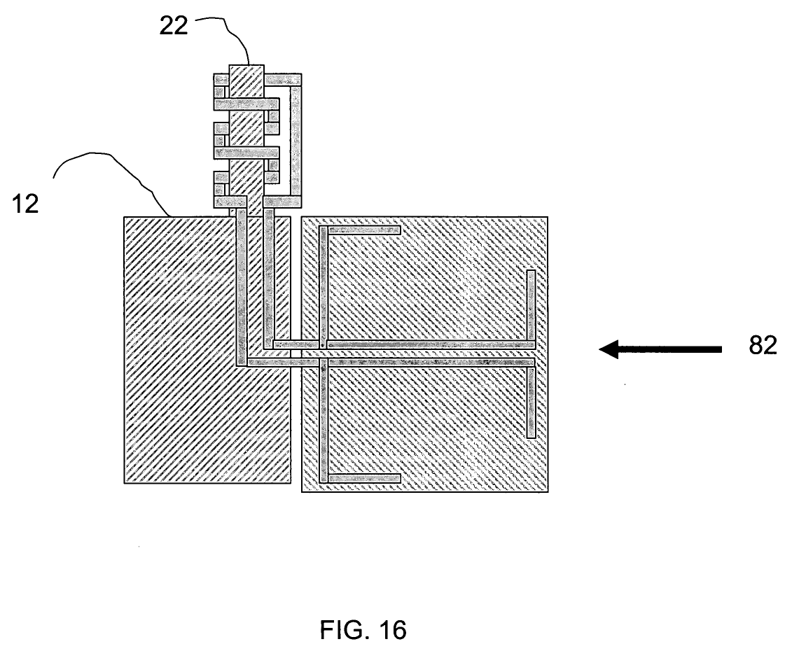

FIG. 16 shows antenna configuration 82 as a flat strip version of the antenna mounted on the antenna 22 of cell phone 12 in one particular relative orientation according to the invention.

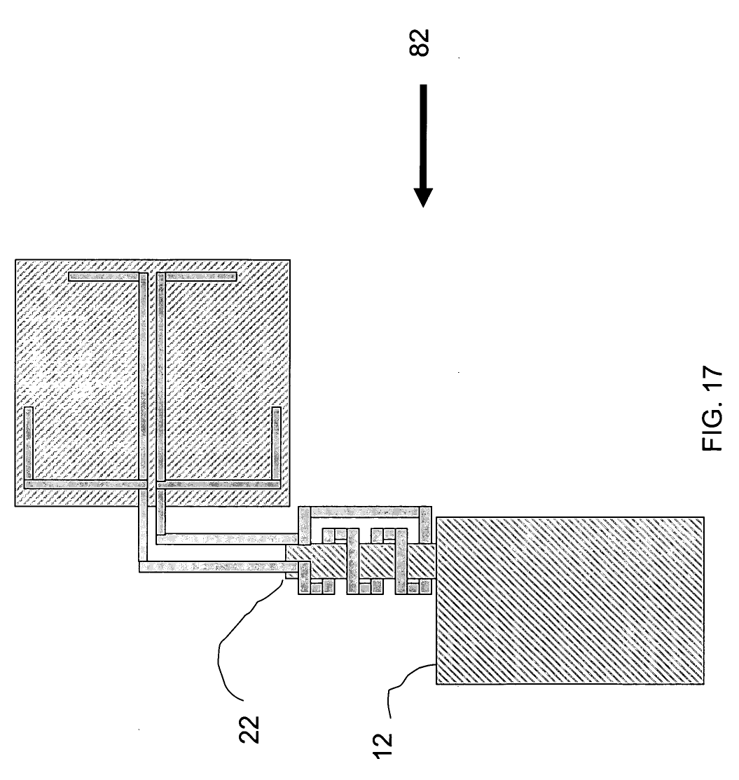

FIG. 17 shows antenna configuration 82 as a flat strip version of the antenna mounted on the antenna 22 of cell phone 12 in a second relative orientation according to the invention. This is the preferred embodiment of the invention.

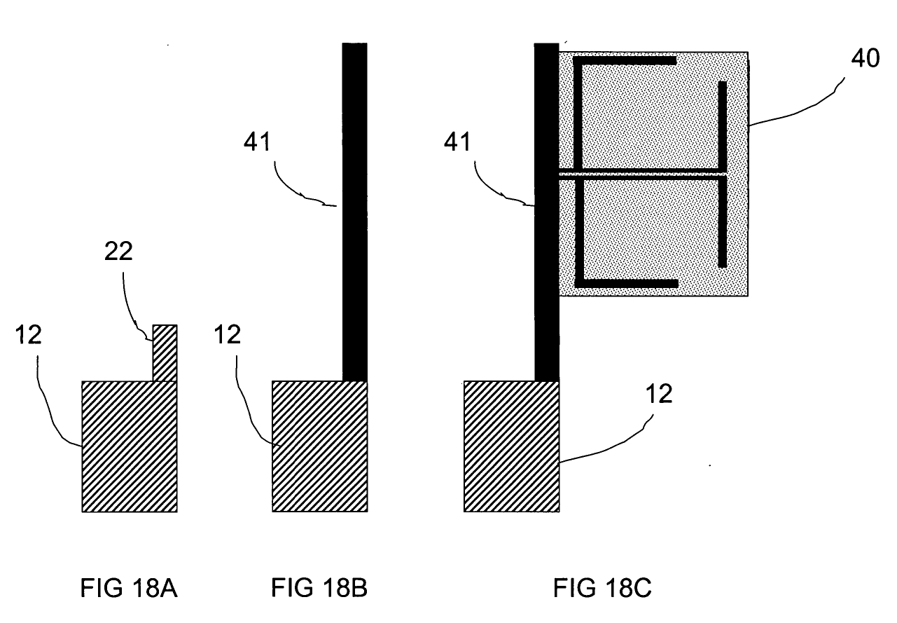

FIG. 18A shows cell phone 12 and cell phone antenna 22 of FIG. 1. FIG. 18B shows the stored antenna configuration 41 of FIGS. 13A and 13B in the container 16 where the stored antenna configuration 41 while still in the container 16 is connected to the cell phone 12 via the cell phone antenna 22, (not shown). FIG. 18C shows the antenna configuration 41 deployed from the storage container 16 on cell phone 12. Preferably, the antenna configuration 41 may be extended out of a slot or other opening (not shown) within the wall of the container and can be inserted back into the container 16 after use for storage.

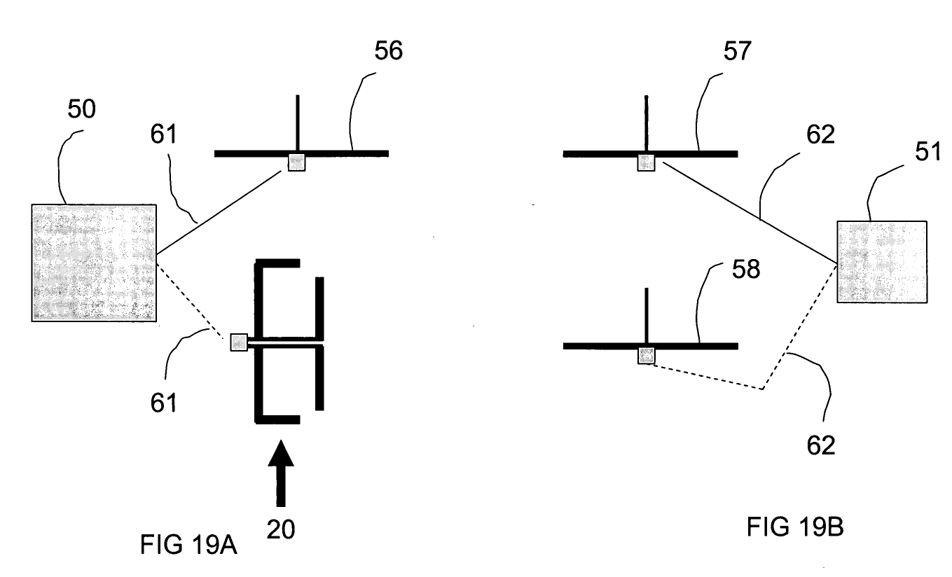

FIGS. 19A and 19B show a test set-up utilized for measuring and optimizing the antenna 20 over the frequency band 1850 MHz to 1990 MHz. Identical monopoles over a metallic ground-plane 56 and 57 and 58 were constructed to operate over the frequency range and utilized as a standard antenna whose performance characteristics are well known to those who practice in the antenna field. A source of RF energy 50 capable of being tuned over the frequency band was connected to antenna 56 via cable 61. The RF output from antenna 57 was noted on detector 51 via cable 62. After a reference signal level was established on detector 51, source 50 was connected to antenna 20 via cable 61 and the output of antenna 58, connected to detector via cable 62 was noted on detector 51. The dimensions and configuration of antenna 20 were adjusted to achieve an equal or superior performance than antenna 57 as displayed on detector 51.

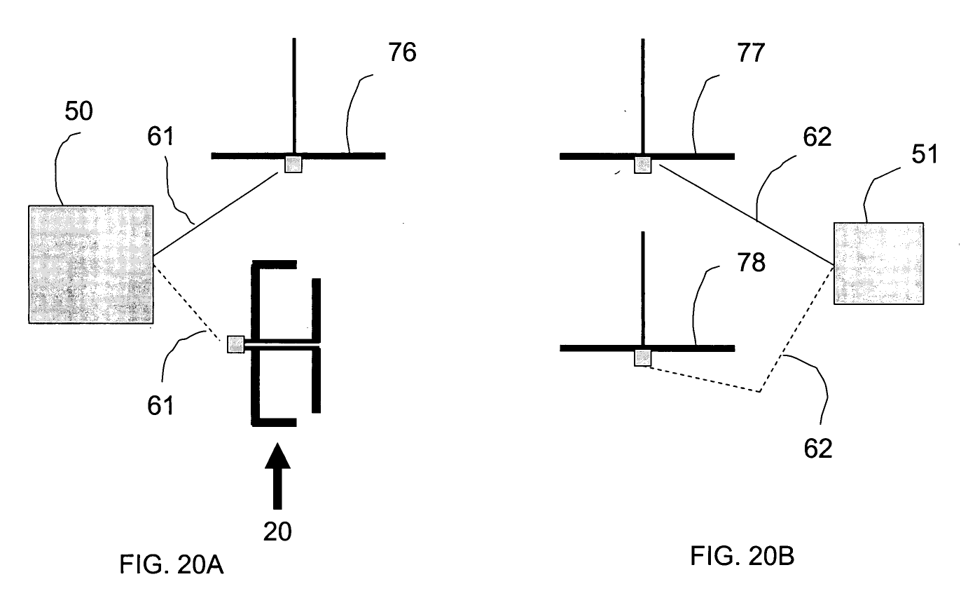

FIGS. 20A and 20B show a test set-up utilized for measuring and optimizing the antenna 20 over the frequency band 806 MHz to 894 MHz. Identical monopoles over a metallic ground-plane 76 and 77 and 78 were constructed to operate over the frequency range and utilized as a standard antenna whose performance characteristics are well known to those who practice in the antenna field. A source of RF energy 50 capable of being tuned over the frequency band was connected to antenna 76 via cable 61. The RF output from antenna 77 was noted on detector 51 via cable 62. After a reference signal level was established on detector 51, source 50 was connected to antenna 20 via cable 61 and the output of antenna 78, connected to detector via cable 62 was noted on detector 51. The dimensions and configuration of antenna 20 were adjusted to achieve an equal or superior performance than antenna 77 as displayed on detector 51. The dipole arms of antenna 20 over the frequency range were bent in order to reduce the cross-section of the overall antenna. The separation between the low frequency antenna and the high frequency antenna was adjusted for optimum performance over both frequency bands.

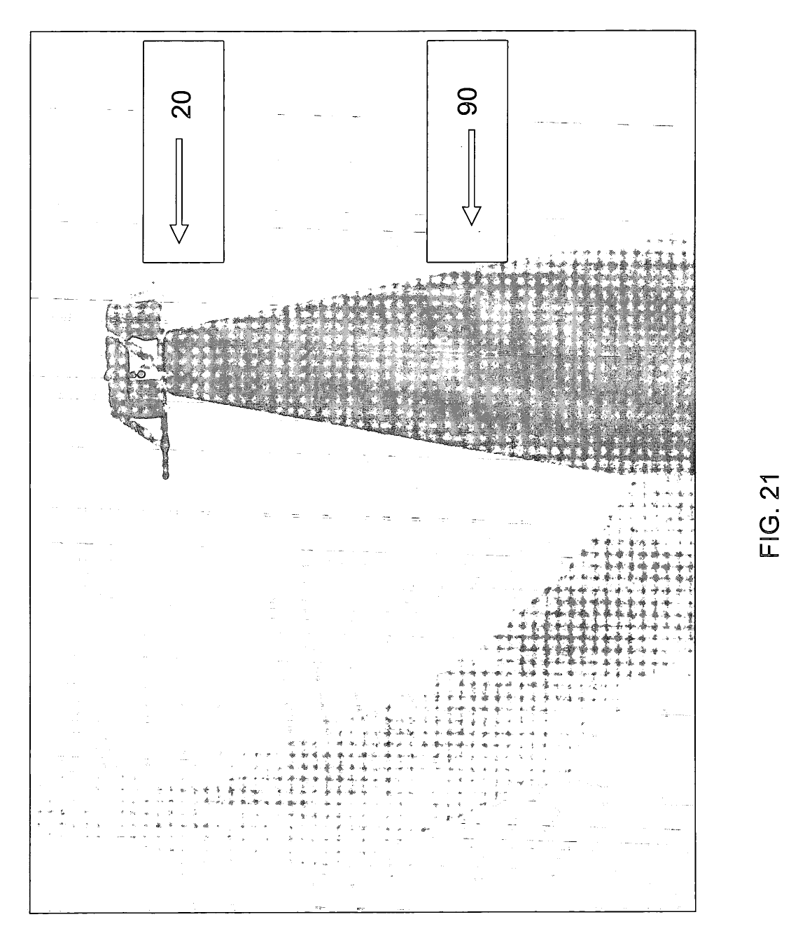

FIG. 21 is a side view of antenna 20 mounted on a foam column 90 in the antenna measurement range at JEM Engineering of Columbia, Md.

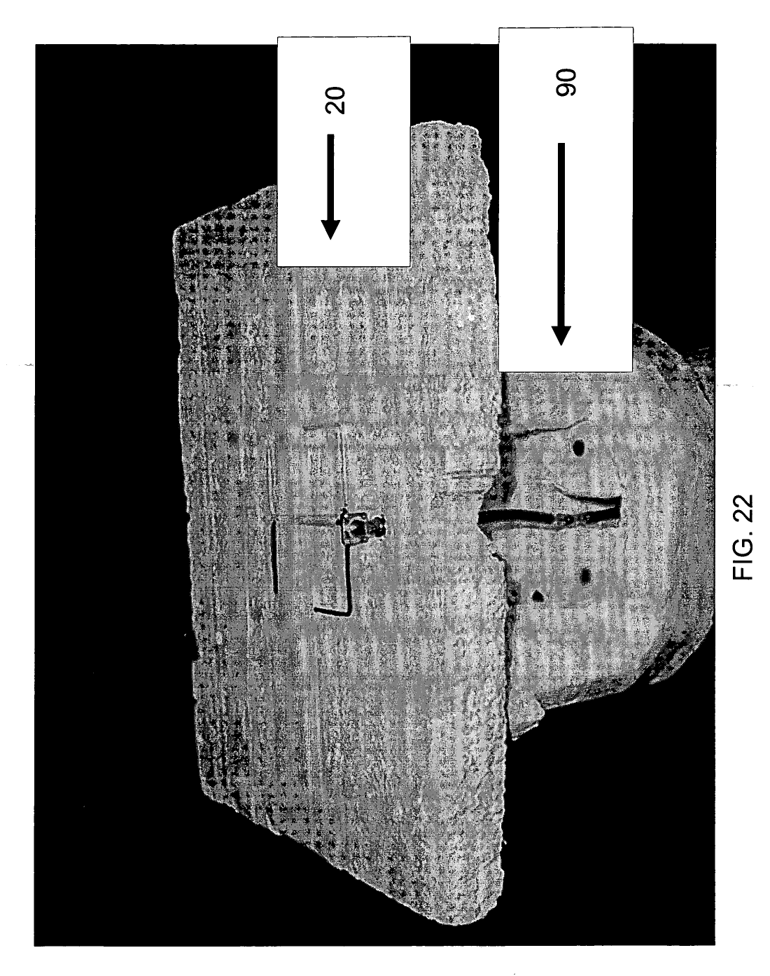

FIG. 22 is a perspective view of antenna 20 mounted on a foam column 90 in the antenna measurement range at JEM Engineering of Columbia, Md.

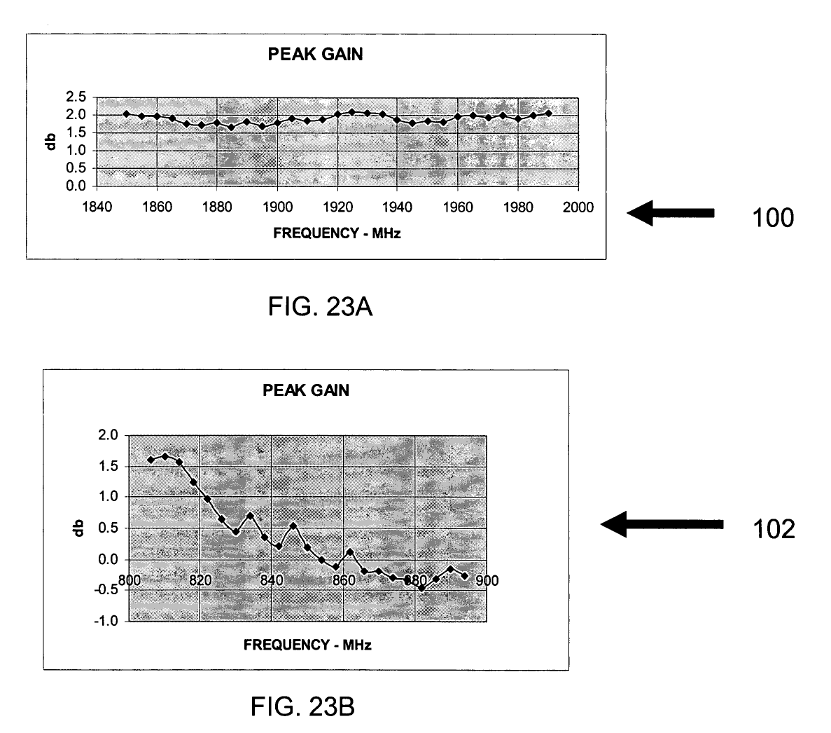

FIGS. 23A and 23B show some of the data taken on antenna 20 in the antenna measurement range at JEM Engineering of Columbia, Md. In particular, shown is the measured peak gain 100 over the frequency range 1850 MHz to 1990 MHz and measured peak gain 102 over the frequency range 806 MHz to 894 MHz.

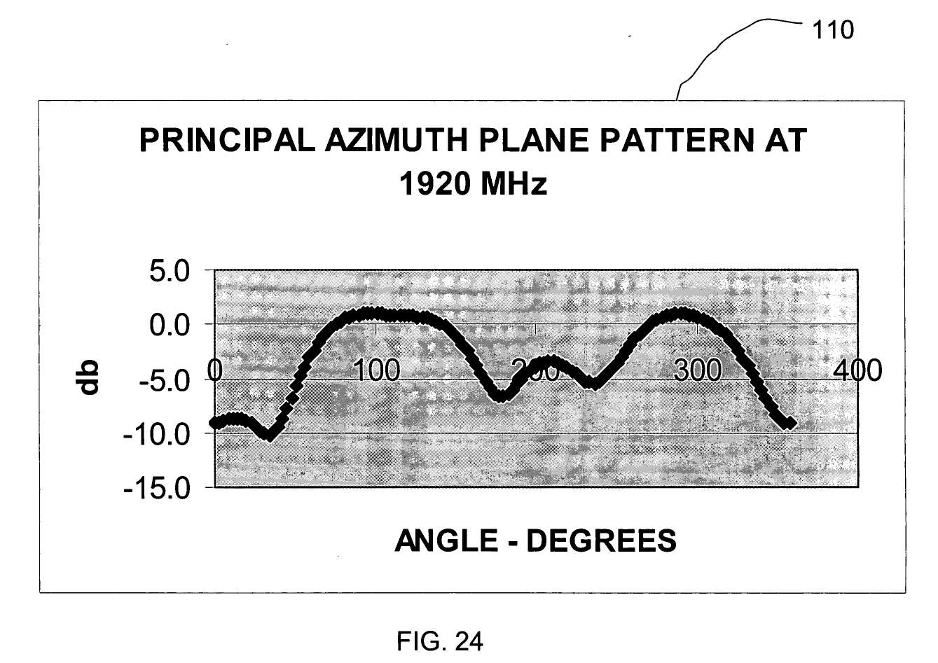

FIG. 24 shows some of the data taken on antenna 20 in the antenna measurement range at JEM Engineering of Columbia, Md. In particular, shown is the measured principal azimuth plane pattern 110 taken at 1920 MHz.

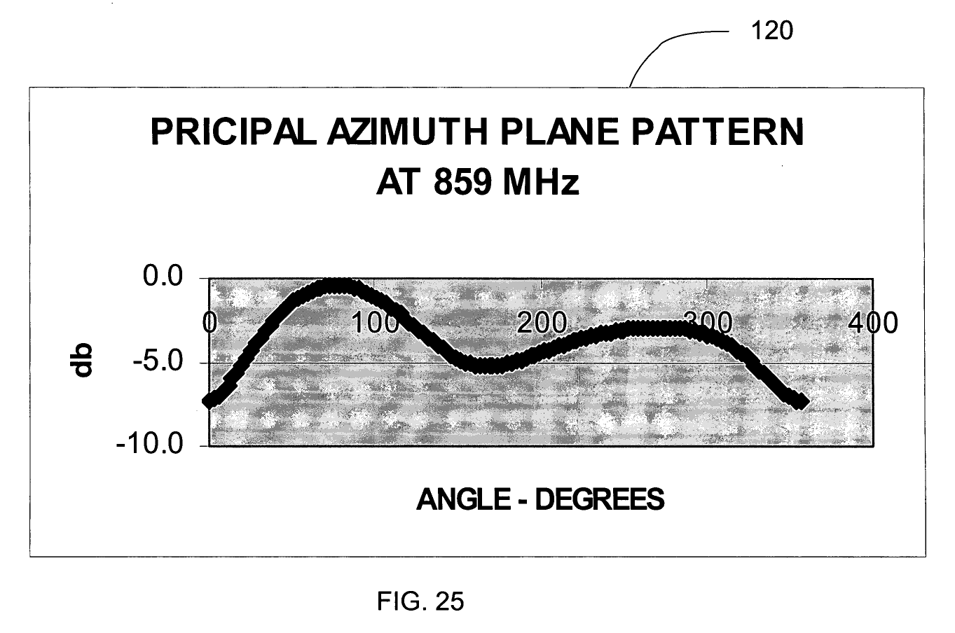

FIG. 25 shows some of the data taken on antenna 20 in the antenna measurement range at JEM Engineering of Columbia, Md. In particular, shown is the measured principal azimuth plane pattern 120 taken at 859 MHz.

The data shown in FIGS. 23A and 23B show that an antenna configuration according to the present invention has a high gain over the two frequency ranges involved in cell phone operation even though the configuration of the present invention is not a “true omnidirectional antenna” which has perfect symmetry in the azimuth plane. The gain shown is comparable to the advertised gain of a Wilson Mini Dual Band Magnetic Mount Antenna which must be mounted on the roof of a car and connected directly to a cell phone via a coaxial connector. This shows the advantage of having a portable antenna with comparable performance available to the cell phone user at any time in any location. The data shown in FIG. 24 and FIG. 25 shows that an antenna according to the present invention has broad azimuth coverage even though the configuration of the present invention is not a “true omnidirectional antenna” which has perfect symmetry in the azimuth plane. This means that use of tan antenna according to the present invention will enable a user to connect to a remote cell phone tower in any relative direction.

FIGS. 9-12 essentially show several ways that an antenna according to the present invention is intended to be utilized. The stored antenna configuration 41 shown in FIGS. 13A and 13B has the size and shape of a fountain pen which can be stored conveniently in a pocket or purse. When mounted to a cell phone as shown in FIGS. 18A, 18B and 18C the stored antenna configuration 41 provides the operational simplicity depicted in FIG. 9.

The use of an antenna according to the present invention is not intended solely for those areas that cannot connect to a cell tower for whatever reason. By utilizing an antenna according to the present invention in areas with a strong connection to a cell tower, the transmitter within the cell phone will reduce its RF power level and this makes the cell phone less likely to cause any health related problems.

The particular signal source 50 was a Hewlett Packard model 8614A Signal Generator. The particular detector 51 was a Hewlett Packard model 415E meter in conjunction with a Wiltron model 74N50 crystal detector. The antenna measurement facility at JEM Engineering in Columbia, Md. is an industry standard Satimo STARGATE System which employs a calibrated nearfield measurement range.

In the preferred embodiment of the invention, the following dimensions were selected:

Dimension d1=3.0 inches

Dimension d2=1.5 inches

Dimension d3=3.5 inches

Dimension d4=4.0 inches

Dimension d5=6.0 inches

Dimension d6=0.5 inches

It will be recognized by those skilled in the art that changes may be made to the above described embodiment of the invention without departing from the broad inventive concepts thereof. For example, the antenna connection to the cell phone may be made via a connector other than the coils which make a wireless connection. In addition, the configuration of the antenna assembly, shown as a generally planar assembly, may be changed to some other configuration while maintaining the portability aspect of the concept. Further, the antenna assembly 14 could be reconfigured and retuned to the frequency of a satellite radio, thus providing the user of such a service enhanced reception. It is understood, therefore, that this invention is not limited to the particular embodiments disclosed, but is intended to cover all modifications to the particular configuration of an external cell phone antenna assembly or the means of connecting the antenna assembly electrically to the cell phone, which are within the scope and spirit of the invention as defined by the appended claims.

I claim:

1. A portable, self contained, dual frequency external antenna configuration for use with a phone, such as a cell phone having an outwardly extending antenna to enhance cell phone operation, the antenna configuration comprising:
a first antenna tuned to a first cell phone operating frequency;
a second antenna tuned to a second cell phone operating frequency;
a connector adapted for making a connection to the cell phone; and
at least one transmission line connecting the first and second antennas to the connector.

2. The antenna configuration of claim 1 wherein the connector is a wireless connector.

3. The antenna configuration of claim 2 wherein the wireless connector comprises multiple loops sized and shaped to surround at least a portion of the cell phone antenna.

4. The antenna configuration of claim 1 wherein the first antenna is tuned to a frequency in the range of about 806 to 894 MHz and the second antenna is tuned to a frequency in the range of about 1850 to 1990 MHz.

5. The antenna configuration of claim 1 wherein the first and second antennas are generally coplanar.

6. The antenna configuration of claim 5 wherein the first and second antennas each have an overall dimension which is generally one half of the wavelength of the respective mid-band first and second cell phone operating frequencies.

7. The antenna configuration of claim 6 wherein at least a portion of the first and second antennas are separated by a distance of about one fourth of the wavelength of the mid-band of the second cell phone operating frequency.

8. The antenna configuration of claim 5 wherein the first and second antennas are fabricated as a printed circuit.

9. The antenna configuration of claim 1, further including a container for receiving the first and second antennas.

10. The antenna configuration of claim 9 wherein the first and second antennas extend outwardly from the container during use.

11. The antenna configuration of claim 1 wherein the antenna configuration is connected directly to and is supported by a cell phone.

12. The antenna configuration of claim 1 wherein the antenna configuration is supported by a user at a location remote from the cell phone.

13. A portable, self contained, external antenna configuration for use with a phone, such as a cell phone having an outwardly extending antenna to enhance cell phone operation, the antenna configuration comprising:
at least a first antenna tuned to a cell phone operating frequency;
a connector adapted for making a connection to the cell phone; and
at least one transmission line connecting the first antenna to the connector.

14. The antenna configuration of claim 13 wherein the connector comprises multiple loops sized and shaped to surround at least a portion of the cell phone antenna.

15. The antenna configuration of claim 13 further comprising a second antenna tuned to another cell phone operating frequency, the at least one transmission line also connecting the second antenna to the connector.

16. The antenna configuration of claim 15 wherein the first antenna is tuned to a frequency in the range of about 806 to 894 MHz and the second antenna is tuned to a frequency in the range of about 1850 to 1990 MHz.

17. The antenna configuration of claim 13 wherein the first and second antennas are generally coplanar.

18. The antenna configuration of claim 17 wherein the first and second antennas are fabricated as a printed circuit.

19. The antenna configuration of claim 13, further including a container for receiving the first and second antennas.

20. The antenna configuration of claim 19 wherein the first and second antennas extend outwardly from the container during use
